(19) United States
(12) Patent Application Publication
(10) Pub. No.: US 2007/0098049 A1
(43) Pub. Date: May 3, 2007

(54) Device and method for encoding a datum, and a device and method for decoding an encoded datum

(76) Inventor: Ian Francis Sharp, West Pymble (AU)

Correspondence Address: LADAS & PARRY, 5670 WILSHIRE BOULEVARD, SUITE 2100, LOS ANGELES, CA, 90036-5679, US

(21) Appl. No.: 10/562,078

(22) PCT Filed: Jun. 24, 2004
(86) PCT No.: PCT/AU04/00830

§ 371 Date: Dec. 27, 2006

(30) Foreign Application Priority Data
Jun. 26, 2003 (AU) 2003903271

(51) Int. Cl. H04B 1/00

(52) U.S. Cl. 375/146

(57) ABSTRACT

A device for encoding a datum, the device being operable to encode the datum by effecting a phase difference between one or more first pseudorandom signals and one or more corresponding second pseudorandom signals.

### FIELD OF THE INVENTION

The present invention relates to a device and method for encoding information (a datum), and a device and method for decoding encoded information. The present invention has particular, but by no means exclusive, application to wireless data communication systems.

### BACKGROUND OF THE INVENTION

To facilitate the transfer of a datum such as voice, video or computer data, communication systems convert the datum to/from a predefined format. The function of converting a datum to/from the predefined format is commonly referred to as encoding/decoding. Examples of rudimentary encoding/decoding techniques include amplitude modulation (AM) and frequency modulation (FM).

### SUMMARY OF THE INVENTION

According to a first aspect of the present invention, there is provided a device for encoding a datum, the device being operable to encode the datum by effecting a phase difference between one or more first pseudorandom signals and one or more corresponding second pseudorandom signals.

Encoding signals using pseudorandom codes has the advantage of providing some degree of immunity from interfering signals and noise, this concept being known as process gain. For typical spread-spectrum encoding there must be a tradeoff between the process gain and the data rate. However, one advantage of the present invention is that up to some limit there is no loss of process gain (or increase in signal bandwidth) as the data rate increases. Thus, the device according to the first aspect of the present invention has the potential to provide a relatively high spectral efficiency. This is advantageous because it provides for high capacity data transmissions in a limited bandwidth environment. Using the device according to the first aspect of the present invention it may be possible to achieve a spectral efficiency of at least around 2 bits per second per hertz.

Preferably, the device is operable to use any one of the first pseudorandom signals as a distinct channel that can be selected to encode the datum.

Thus, by treating each of the first pseudorandom signals as distinct channels the device according to the first aspect of the present invention is capable of providing a multiple access scheme capable of supporting multiple users.

Alternatively, the device is operable to use a plurality of the first pseudorandom signals as a single channel that can be selected to encode the datum.

The advantage of using the plurality of first pseudorandom signals is that it provides a higher overall data rate than using just one of the first pseudorandom signals as a channel.

Preferably, the device is operable to effect the phase difference by controlling a signal generating means, which is arranged to generate the first pseudorandom signals, such that it outputs a symbol of each of the first pseudorandom signals at a predetermined time, wherein the predetermined time results in the phase difference between the symbol and a corresponding symbol in each of the second pseudorandom signals.

Thus, the datum is encoded as a phase difference between the first and second pseudorandom signals, where the phase represents the time difference between the epochs of the respective pseudorandom signals.

Preferably, the datum comprises a signal encoded with information.

Thus, this effectively allows the device to be used in conjunction with existing data modulation schemes, such as amplitude modulation, phase modulation or quadrative-amplitude modulation. Because the pseudorandom sequence phase is orthogonal to the sequence amplitude and the signal phase, the total data rate can be increased without changing the transmission bandwidth or the spread-spectrum process gain.

Preferably, the first pseudorandom signals and second pseudorandom signals are in the form of direct sequence spread-spectrum signals.

According to a second aspect of the present invention, there is provided a device for decoding an encoded datum, the device being operable to decode the encoded datum by determining a phase difference between one or more first pseudorandom signals and one or more corresponding second pseudorandom signals.

Preferably, the device is operable to use the first pseudorandom signals as a distinct channel that can be selected to decode the datum.

Alternatively, the device is operable to use a plurality of the first pseudorandom signals as a single channel that can be selected to decode the datum.

Preferably, the device is operable to determine the phase difference based on a time difference between a symbol of each of the first pseudorandom signals and a corresponding symbol of each of the second pseudorandom signals, wherein the time difference is representative of the phase difference.

Preferably, the datum comprises a signal encoded with information.

Preferably, the first pseudorandom signals and second pseudorandom signals are in the form of direct sequence spread-spectrum signals.

According to a third aspect of the present invention, there is provided a method of encoding a datum, the method comprising the step of encoding the datum by effecting a phase difference between one or more first pseudorandom signals and one or more corresponding second pseudorandom signals.

Preferably, the step of encoding the datum comprises the step of using any one of the first pseudorandom signals as a distinct channel that can be selected to encode the datum.

Alternatively, the step of encoding the datum comprises using a plurality of first pseudorandom signals as a single channel that can be selected to encode the datum.

Preferably, the step of encoding the datum is such that the phase difference is effected by controlling a signal generating means, which is arranged to generate the first pseudorandom signals, such that it outputs a symbol of each of the first pseudorandom signals at a predetermined time, wherein the predetermined time results in the phase difference between the symbol and a corresponding symbol in each of the second pseudorandom signals.

Preferably, the datum comprises a signal encoded with information.

Preferably, the first pseudorandom signals and second pseudorandom signals are in the form of direct sequence spread-spectrum signals.

According to a fourth aspect of the present invention, there is provided a method of decoding an encoded datum, the method comprising the step of decoding the encoded datum by determining a phase difference between one or more first pseudorandom signals and one or more corresponding second pseudorandom signals.

Preferably, the step of decoding the encoded datum comprises the step of using any one of the first pseudorandom signals as a separate channel that can be selected to decode the datum.

Alternatively, the step of decoding the encoded datum comprises the step of using a plurality of the first pseudorandom signals as a single channel that can be selected to decode the datum.

Preferably, the step of decoding the encoded datum is such that the phase difference is determined by a time difference between a symbol of each of the first pseudorandom signals and a corresponding symbol of each of the second pseudorandom signals, wherein the time difference is representative of the phase difference.

Preferably, the datum comprises a signal encoded with information.

Preferably, the first pseudorandom signals and second pseudorandom signals are in the form of direct sequence spread-spectrum signals.

According to a fifth aspect of the present invention there is provided software, which when executed by a computing device, enables the computing device to carry out the method as described in the paragraphs referring to the third or fourth aspects of the invention.

According to a sixth aspect of the present invention there is provided a computer readable medium comprising the software described in the paragraph referring to the fifth aspect of the present invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 provides an illustration of a block diagram of the preferred embodiment of a device for encoding a datum;

FIG. 2 provides an illustration of a representation of a pseudo-noise sequence generated by the device shown in FIG. 1;

FIG. 3 provides an illustration of a block diagram of a pseudo-noise sequence generator used in the device of FIG. 1; and

FIG. 4 provides an illustration of a block diagram of the preferred embodiment of a device for decoding a datum that has been encoded using the device shown in FIG. 1; and

FIG. 5 provides an illustration of a correlogram showing the correlation relationship between signal strength and phase difference (correlation time) of two bandlimited pseudorandom signals;

FIG. 6 provides a flow chart of the steps performed by the device of FIG. 1;

FIG. 7 provides a flow chart of the steps performed by the device of FIG. 4;

FIG. 8 provides an illustration of the use of channels by the device of FIG. 1; and

FIG. 9 provides another illustration of the use of channels by the device of FIG. 1.

### AN EMBODIMENT OF THE INVENTION

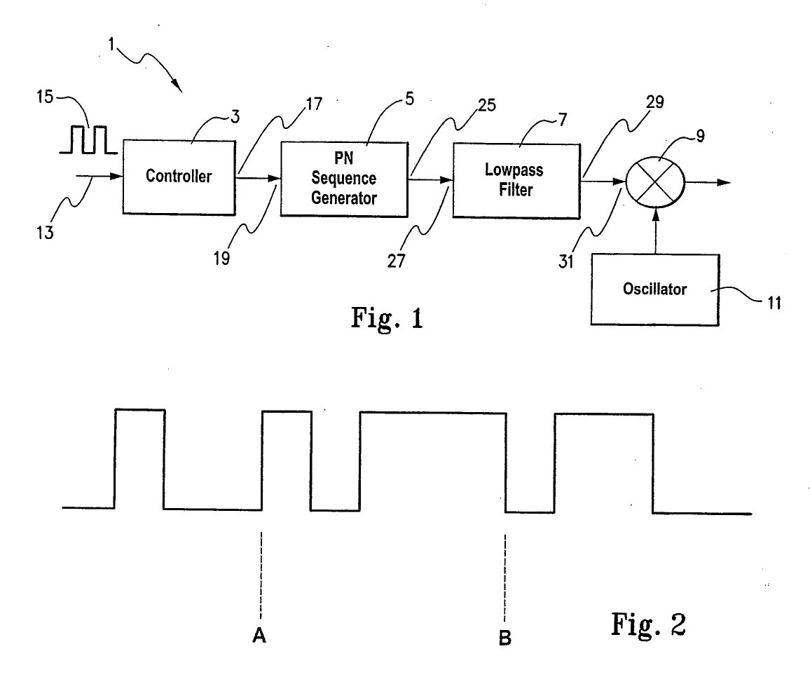

As can be seen in FIG. 1, an embodiment of the device 1 for encoding a datum comprises a controller 3, a pseudorandom sequence generator 5, a lowpass filter 7, a modulation circuit 9, and an oscillator 11.

The controller 3 is in the form of a digital integrated circuit that has an input port 13 for receiving the datum 15 that is to be encoded. The datum 15 is in the form of a series of binary bits that are representative of, for example, voice or computer data. It is also envisaged that the datum 15 could be in the form of a signal that is encoded with information. For example, the signal could be encoded using existing modulation techniques such as amplitude modulation, phase modulation or quadrative-amplitude modulation. Where the series of binary bits forming the datum 15 are representative of analogue information (such as voice), the analogue information is converted to the series of binary bits by an analogue to digital converter (not shown in the figures).

The controller 3 is such that it is configured to process the datum 15 and create a control signal that is unique to the sequence of binary bits that form the datum 15. The control signal is also in the form of binary data. The controller 3 forwards the control signal to the pseudorandom sequence generator 5 via an output port 17, which is connected to an input port 19 of the pseudorandom generator 5.

The pseudorandom sequence generator 5, which is in the form of a digital integrated circuit, generates one or more first pseudorandom sequences that, as discussed shortly, are used to encode the datum 15. Each pseudorandom sequence is orthogonal to any other pseudorandom sequence created by the pseudorandom sequence generator 5. An example of a pseudorandom sequence is shown in FIG. 2.

The pseudorandom sequences are generated by using a read-only memory (ROM), the size of which is related to the number of pseudorandom sequences and the length of the sequences. Each pseudorandom sequence has a start address in the ROM, so the input data on port 19 can be converted to an appropriate ROM address. In the case where the pseudorandom sequences are simply a shifted version of one another, the input data can be converted into a ROM address plus an offset, with the address wrapping around when the end of the sequence is reached.

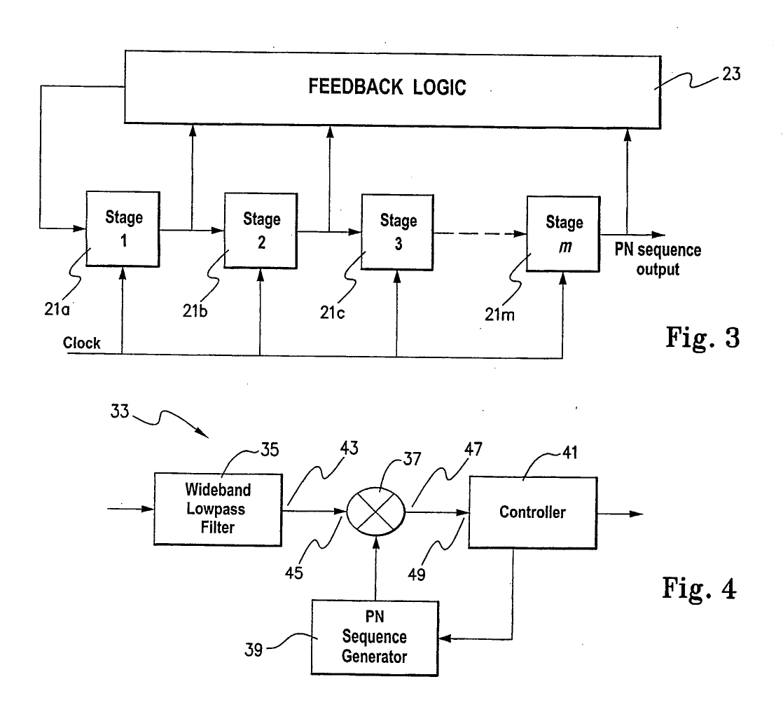

It will be appreciated that other techniques can be used to generate the pseudorandom sequences. One such technique that may be to employ shift registers with a number of feedback paths. A block diagram of the digital logic used in each of the shift registers is shown in FIG. 3. Each feedback shift register includes consecutive stages of two-state memory devices 21 and feedback logic 23, which is in the form of exclusive-OR gates.

The pattern of the feedback paths determine the pseudorandom sequences produced, while the initial pattern in the shift register determines the starting bit of the pseudorandom sequences. Configuring the feedback shift registers to generate pseudorandom sequences is achieved by loading the memory devices 21 with an appropriate binary sequence. Alternatively, multiple shift registers can be used to generate each sequence required. If the pseudorandom sequences are based on a maximum-length sequence, then the sequences will have good cross-correlation properties when correlated with a shifted version of itself, and thus the sequences are essentially orthogonal to each other.

In order to encode the datum 15, the pseudorandom sequence generator 5 commences ‘clocking-out’ (outputting) each of the pseudorandom sequences from a specific point (bit) of each of the pseudorandom sequences. For example, if the binary bits forming the datum 15 were 1010, the pseudorandom sequence generator 5 could commence clocking-out of the pseudorandom sequence from section “A” (see FIG. 2). On the other hand, if the datum 15 consisted of 0011, the pseudorandom sequence generator 5 could commence clocking-out of the pseudorandom sequence from section “B” (see FIG. 2).

As will be discussed shortly, the section from which clocking-out of each of the first pseudorandom sequences commences effects a phase difference between the first pseudorandom sequences and the second pseudorandom sequences, the phase difference being representative of the encoded datum 15.

The point from which clocking-out of the first pseudorandom sequences commences is actually controlled by the control signal that is created by the controller 3, which as discussed previously, is fed to the pseudorandom sequence generator 5. Upon receiving the control signal, the pseudorandom sequence generator 5 uses the control signal to determine the sections of the first pseudorandom sequences from which clocking-out is to commence.

Once the first pseudorandom sequences have been generated, the pseudorandom sequence generator 5 forwards the first pseudorandom sequences to an output port 25, which is connected to an input port 27 of the lowpass filter 7. The first pseudorandom sequences pass through the filter 7, which removes unwanted high frequency components from the first pseudorandom sequences. The filtered first pseudorandom sequences are then passed to the modulation circuit 9 via an output port 29 of the lowpass filter 7, which is connected to an input port 31 of the modulation circuit 9. The lowpass filter 7 is in the form of a digital filter that is implemented in hardware (digital integrated circuit). It will be appreciated, however, that an analogue filter could be used in an alternative embodiment of the present invention.

In addition to the filtered first pseudorandom sequences, the modulation circuit 9 receives a separate radio frequency signal for each filtered first pseudorandom sequence from the oscillator 11. The modulation circuit 9 uses the filtered first pseudorandom sequences to modulate the corresponding radio frequency signals (received from the oscillator 11) using binary RF phase modulation to produce a number of spread-spectrum signals.

The device 1 transmits the spread-spectrum signals to a receiver. Whilst not shown in the figures, the device 1 comprises circuitry that is arranged to process the spread-spectrum signals (for example, amplification) before they are transmitted to the receiver. The processed spread-spectrum signals are fed to an antenna so that they can be transmitted to the receiver.

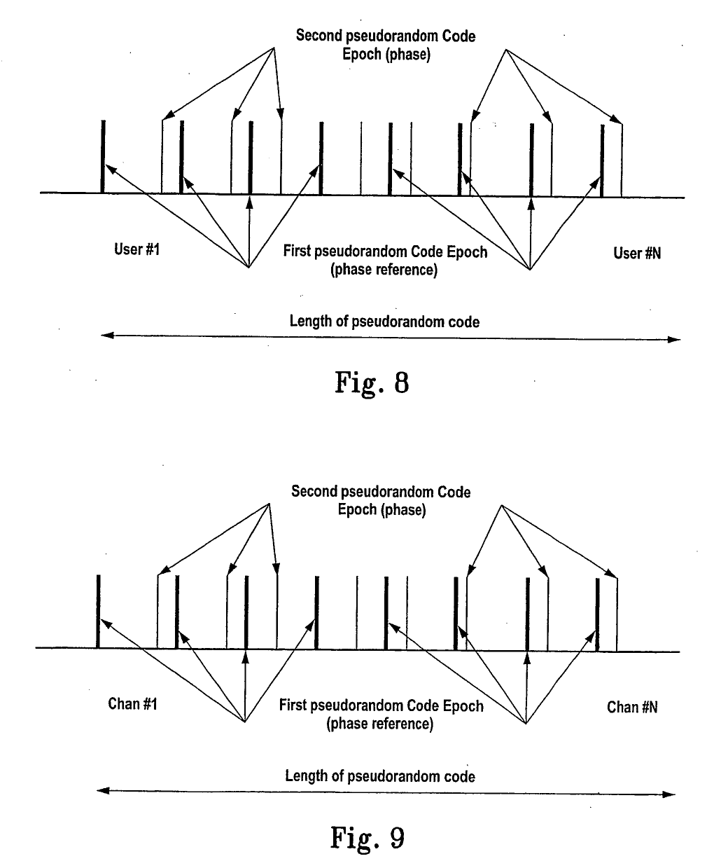

The device 1 is arranged to either use each of the first pseudorandom sequences as distinct channels that can be used to encode the datum 15, or use a plurality of the first pseudorandom sequences as a single channel for encoding the datum 15. In this regard, FIG. 8 provides an illustration of the concept of using a single channel for a user (multiple access scheme), whilst FIG. 9 provides an illustration of the concept of using multiple channels for a single user.

To decode the datum 15 from the spread-spectrum signals transmitted by the device 1, the receiver comprises a device 33 illustrated in FIG. 4. The device 33 comprises an RF bandpass filter 35, a demodulator 37, a pseudorandom sequence generator 39, and a controller 41.

Although not illustrated, the device 33 also comprises receiver circuitry that carries out initial processing of the received spread-spectrum signals (for example, amplification). Once the initial processing of the spread-spectrum signals has been carried out, the receiver circuitry forwards the spread-spectrum signals to the lowpass filter 35 so that unwanted components can be removed from the spread-spectrum signals. The filtered spread-spectrum signals are fed to an output port 43 of the filter 35. The output port 43 is connected to an input port 45 of the demodulator 37 so that the filtered spread-spectrum signals are passed to the demodulator 37. The filter 35 is a digital filter implemented in hardware. However, it will be appreciated that an analogue filter could be used in an alternative embodiment of the present invention.

In addition to receiving the filtered spread-spectrum signals, the demodulator 37, which is in the form of a suitably programmed digital signal processor, also receives second pseudorandom sequences from the pseudorandom sequence generator 39. The pseudorandom sequence generator 39 generates the second pseudorandom sequences using feedback shift registers that are the same as those used in the pseudorandom sequence generator 5.

Each of the second pseudorandom sequences received by the demodulator 37 corresponds to one of the received spread-spectrum signals. The second pseudorandom sequences generated by the pseudorandom sequence generator 39 are the same as the pseudorandom sequences generated by the pseudorandom sequence generator 5. The demodulator 37 multiplies each of the filtered spread-spectrum signals by the second pseudorandom sequence that corresponds thereto. The multiplication process extracts a number of signals from the filtered spread-spectrum signals. The process of multiplication and integrating over a period equal to the length of the code effectively generates the cross-correlation between the transmitted sequences and the second sequence in the receiver.

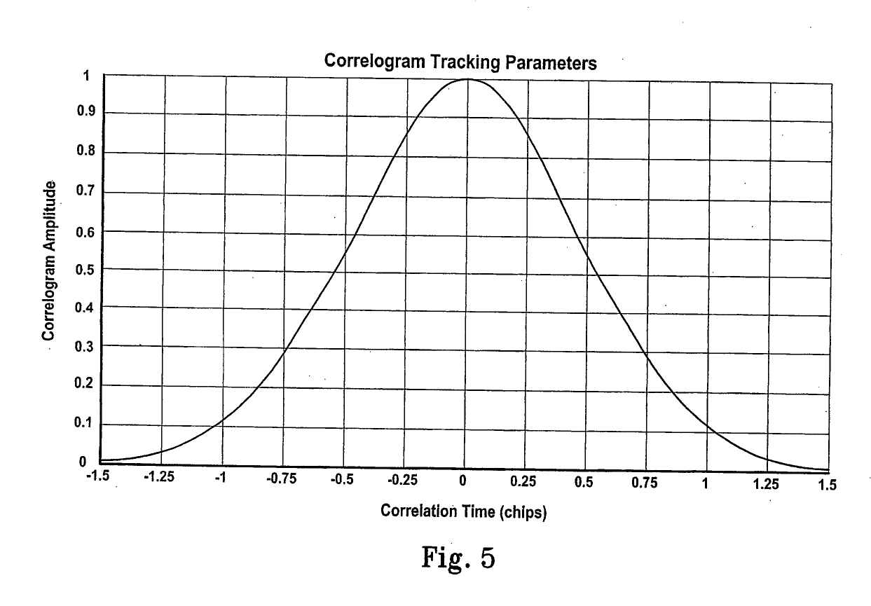

The output of the correlator has a strength (amplitude) that is dependant on the code phase difference between the received spread-spectrum signals and the corresponding second pseudorandom sequence generated by the pseudorandom sequence generator 39. The relationship between the code phase difference and the signal strength is represented in the correlogram shown in FIG. 5.

The demodulator 37 is arranged to create information that is indicative of the strength of each of the signals that are extracted by the multiplication and integration process. The demodulator 37 places the information on output port 47 of the demodulator 37 so that it can be passed to the controller 41 via an input port 49 thereof, which is connected to the output 47 of the demodulator 37.

The controller 41, which is in the form of a suitably programmed microprocessor, is arranged to decode the encoded datum 15 by determining a phase difference between the spread-spectrum signals received by the demodulator 37 and the corresponding second pseudorandom sequences generated by the generator 39. The phase difference is such that it corresponds to a maximum strength of the signals extracted by the correlation process. An example of the correlation output as a function of correlation time (phase) is shown in FIG. 5. The width of the correlation pulse is about twice the chip period of the pseudorandom signal.

To determine the phase difference, the controller 41 processes the information received via the input port 49 so as to determine the strength of the signals extracted by the correlation process. While monitoring the strength of the signals, the controller 41 controls the pseudorandom sequence generator 39 such that the second pseudorandom sequences generated thereby are ‘shifted’ in time to a point where the strength of the signals are at a peak. The controller 41 measures the amount of the shift in time of the second pseudorandom sequences that results in the signals having a peak signal strength. The amount of shift in time required to produce the peak signal strength is effectively equivalent to the phase difference created by the ‘transmitter device 1.

Once the phase difference has been determined, the controller 41 essentially refers to a form of look up table to determine a binary sequence which corresponds to the phase difference. The corresponding binary sequence being the same as the datum 15 encoded by the device 1.

In order to shift the second pseudorandom sequences in time, the controller and the pseudorandom sequence generator 39 use the same clocking out technique as employed by the controller 3 and the pseudorandom sequence generator 5.

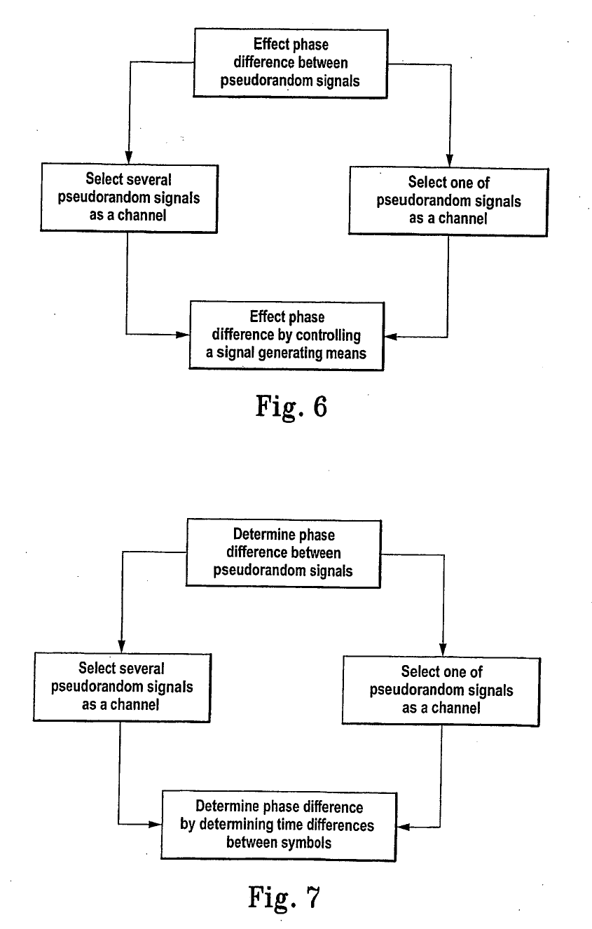

The various steps carried out to encode the datum 15 are shown in the flow chart of FIG. 6, whilst the steps performed to decode the datum are shown in the flow chart of FIG. 7.

It will be appreciated that whilst the description of the embodiment refers to the use of hardware to implement the various functionality associated with the present invention, it is possible to use other embodiments in which the functionality is embodied in software for use with suitable hardware.

It is noted that the word “phase” throughout the present specification is considered to have its ordinary meaning of: the relationship in time between the cycles of an oscillating or repeating system and a fixed reference point or a different system.

Those skilled in the art will operate that the invention described herein is susceptible to variations and modifications other than those specifically described. It should be understood that the invention comprises all such variations and modifications that fall within the spirit and scope of the invention.

1. A device for encoding a datum, the device being operable to encode the datum by effecting a phase difference between one or more first pseudorandom signals and one or more corresponding second pseudorandom signals.

2. The device as claimed in claim 1, wherein the device is operable to use any one of the first pseudorandom signals as a distinct channel that can be selected to encode the datum.

3. The device as claimed in claim 1, wherein the device is operable to use a plurality of the first pseudorandom signals as a single channel that can be used to encode the datum.

4. The device as claimed in claim 3, wherein the device is operable to effect the phase difference by controlling a signal generating means, which is arranged to generate the first pseudorandom signals, such that it outputs a symbol of each of the first pseudorandom signals at a predetermined time, wherein the predetermined time results in the phase difference between the symbol and a corresponding symbol in each of the second pseudorandom signals.

5. The device as claimed in claim 4, wherein the datum comprises a signal encoded with information.

6. The device as claimed in claim 5, wherein the first pseudorandom signals and second pseudorandom signals are in the form of direct sequence spread-spectrum signals.

7. A device for decoding an encoded datum, the device being operable to decode the encoded datum by determining a phase difference between one or more first pseudorandom signals and one or more corresponding second pseudorandom signals.

8. The device as claimed in claim 7, wherein the device is operable to use any one of the first pseudorandom signals as a distinct channel that can be selected to decode the datum.

9. The device as claimed in claim 7, wherein the device is operable to use a plurality of the first pseudorandom signals as a single channel that can be selected to decode the datum.

10. The device as claimed in claim 7, wherein the device is operable to determine the phase difference by determining a time difference between a symbol of each of the first pseudorandom signals and a corresponding symbol of each of the first pseudorandom signals, wherein the time difference is representative of the phase difference.

11. The device as claimed in claim 7, wherein the datum comprises a signal encoded with information.

12. The device as claimed in claim 7, wherein the first pseudorandom signals and second pseudorandom signals are in the form of direct sequence spread-spectrum signals.

13. A method of encoding a datum, the method comprising the step of encoding the datum by effecting a phase difference between one or more first pseudorandom signals and one or more corresponding second pseudorandom signals.

14. The method as claimed in claim 13, wherein the step of encoding the datum comprises using any one of the first pseudorandom signals as a separate channel that can be selected to encode the datum.

15. The method as claimed in claim 13, wherein the step of encoding the datum comprises the step of using a plurality of the first pseudorandom signals as a single channel that can be selected to encode the datum.

16. The method as claimed in claim 13, wherein the step of encoding the datum is such that the phase difference is effected by controlling a signal generating means, which is arranged to generate the first pseudorandom signals, such that it outputs a symbol of each of the first pseudorandom signals at a predetermined time, wherein the predetermined time results in the phase difference between the symbol and a corresponding symbol in each of the second pseudorandom signals.

17. The method as claimed in claim 13, wherein the datum comprises a signal encoded with information.

18. The method as claimed in claim 13, wherein the first pseudorandom signals and second pseudorandom signals are in the form of direct sequence spread-spectrum signals.

19. A method of decoding an encoded datum, the method comprising the step of decoding the encoded datum by determining a phase difference between one or more first pseudorandom signals and one or more corresponding second pseudorandom signals.

20. The method as claimed in claim 19, wherein the step of decoding the encoded datum comprises the step of using any one of the first pseudorandom signals as a distinct channel that can be selected to decode the datum.

21. The method as claimed in claim 19, wherein the step of decoding the encoded datum comprises the step of using a plurality of the first pseudorandom signals as a single channel that can be selected to decode the datum.

22. The method as claimed in claim 19, wherein the step of decoding the encoded datum is such that the phase difference is determined by a time difference between a symbol of each of the first pseudorandom signals and a corresponding symbol of each of the second pseudorandom signals, wherein the time difference is representative of the phase difference.

23. The method as claimed in claim 19, wherein the datum comprises a signal encoded with information.

24. The method as claimed in claim 19, wherein the first pseudorandom signals and second pseudorandom signals are in the form of direct sequence spread-spectrum signals.

25. Software, which when executed by a computing device, enables the computing device to carry out the method as claimed in claim 13.

26. A computer readable medium comprising the software as claimed in claim 25.
